(19) United States
(12) Patent Application Publication
(10) Pub. No.: US 2018/0088094 A1
(43) Pub. Date: Mar. 29, 2018

(54) MULTIPLE ATTRIBUTE MONITORING METHODOLOGIES FOR COMPLEX SAMPLES

(71) Applicant: Waters Technologies Corporation, Milford, MA (US)

(72) Inventors: Ying-Qing Yu, Uxbridge, MA (US); Henry Y. Shion, Hopkinton, MA (US); Scott J. Berger, Hudson, MA (US); Jing Fang, Shrewsbury, MA (US); Liuxi Chen, Saratoga, CA (US); Min Du, Acton, MA (US)

(73) Assignee: Waters Technologies Corporation, Milford, MA (US)

(21) Appl. No.: 15/716,659

(22) Filed: Sep. 27, 2017

Related U.S. Application Data
(60) Provisional application No. 62/400,283, filed on Sep. 27, 2016.

(51) Int. Cl. G01N 30/72; H01J 49/00

(52) U.S. Cl. CPC G01N 30/72; G01N 2030/062; H01J 49/009

(57) ABSTRACT

The present disclosure relates generally to a method of multiple attribute monitoring for biological and other complex compounds using a chromatography-optical detector-mass spectrometry method. The mass spectrometry method can use a high resolution mass spectrometer. The methodology utilizes similar analytical techniques and instruments for both the characterization and the monitoring of biological and other complex compounds.

### RELATED APPLICATIONS

This application claims priority to U.S. Provisional Patent Application Ser. No. 62/400,283 entitled “Multiple Attribute Monitoring Methodologies for Complex Samples,” filed on Sep. 27, 2016, the content of which is hereby incorporated by reference in its entirety.

### TECHNICAL FIELD OF THE INVENTION

The present disclosure relates generally to a method of multiple attribute monitoring for biological and other complex compounds using a chromatography-optical detector-mass spectrometry method. The mass spectrometry method can use a high resolution mass spectrometer (HRMS) and high resolution analytics. The methodology utilizes similar analytical techniques and instruments for both the characterization and the monitoring of biological and other complex compounds.

### BACKGROUND OF THE INVENTION

Multi-Attribute Methodology (MAM) refers to the development of single assays or methods that can assess multiple product attributes which traditionally are performed using an array of conventional methods. For example, MAM allows for the detection and measurement of multiple critical quality attributes in a single analysis. MAM has been applied to the characterization and testing of small molecules. Yet, MAM has not been fully transferred to the analysis of large biological molecules, biopharmaceutical products or otherwise complex samples.

### SUMMARY OF THE INVENTION

The present disclosure relates to the use of orthogonal detectors, e.g., optical detectors and mass spectrometer, for multiple attribute monitoring of biological and other complex samples. The methodology can characterize and test multiple critical quality attributes of complex molecules and is applicable to regulatory monitoring and quality control analyses. Characterization and monitoring can be performed using time aligned optical and mass data to increase confidence of biological and complex sample identification and production. Characterization and monitoring can also be performed using the same, or similar, platform, instrumentation, software, etc. The time aligned optical and mass data and common platform can allow for the reduction or even elimination of conventional testing steps and the efficient transfer of methodology for regulatory monitoring using both optical and mass data, or using optical data itself. The methodology can also be quickly and easily updated for new attributes upon the discovery of new components during monitoring. By use of the same or similar platform, the data (UV, MS, etc.) can be analyzed to identify and correlate new components to new attributes for future monitoring.

In one embodiment, the present disclosure relates to a method of multiple attribute(s) analysis monitoring for a biological compound including (i) characterizing a biological compound standard using a chromatography-optical detector-high resolution mass spectrometry method (e.g., LC/UV/MS), wherein the characterization includes (ia) separating the biological compound using the chromatography-optical detector and high resolution mass spectrometry method, identifying and quantifying peaks generated by the optical detector and accurate masses generated by the high resolution mass spectrometry, storing the accurate mass information in a library as accurate mass reference standard information, (ib) exposing the biological compound standard to a first condition related to a first attribute wherein the first condition induces at least one first chemical change to the biological compound standard, (ic) separating the biological compound exposed to the first condition using the chromatography-optical detector-high resolution mass spectrometry method, identifying and quantifying peaks generated by the optical detector and accurate masses generated by the high resolution mass spectrometry, comparing the accurate masses from the first condition with the accurate mass reference standard information to identify differences; and storing the accurate mass information from the first condition related to the first attribute in the library as a first list of targeted components, (ii) determining at least one quality attribute control limit related to the first list of targeted compounds and (iii) testing a biological compound sample using the chromatography-optical detector-high resolution mass spectrometry method, wherein the testing includes (iiia) separating the biological compound sample using the chromatography-optical detector-high resolution mass spectrometry method, identifying and quantifying peaks generated by the optical detector and accurate masses generated by the high resolution mass spectrometry, and (iiib) comparing the identity and quantity of the biological compound standard peaks and accurate mass information to the library of peaks and accurate masses related to the biological compound sample and the first list of targeted components, and (iiic) determining if the at least one quality attribute control limit related to the first attribute has been exceeded.

The chromatography-optical detector-mass spectrometry method can be operated in data dependent or data independent acquisition mode. The elution time of the UV peaks, the elution time of the component peaks in mass spectrometry chromatogram, or both are adjusted to match. The targeted components, including the first list of targeted components, can be characterized by retention time, neutral mass, confirmatory fragments, drift time, collisional cross section area (CCS) or combinations thereof.

The biological compound or sample be a protein, peptides, oligonucleotide or oligosaccharide. The conditions tested to stimulate modifications in the biological sample can be related to an attribute selected from the group consisting of deamidation assessment, isomerization assessment, glycation assessment, high mannose assessment, methionine oxidation assessment, signal peptide assessment, unusual glycosylation assessment, CDR tryptophan degradation assessment, non-consensus glycosylation assessment, n-terminal pyroglutamate assessment, n-terminal truncation assessment, c-terminal lysine assessment, galactosylation assessment, host cell protein assessment, mutations/misincorporations assessment, hydroxylysine assessment, thioether assessment, non-glycosylated heavy change assessment, fucosylation assessment, residual protein A assessment and identity assessment.

The method can further include evaluating multiple attributes. The method can include exposing the biological compound standard to a second condition related to a second attribute wherein the second condition induces at least one second chemical change to the biological compound standard, separating the biological compound exposed to the second condition using the chromatography-optical detector-high resolution mass spectrometry method, identifying and quantifying peaks generated by the optical detector and accurate mass generated by the high resolution mass spectrometry, comparing the accurate masses from the second condition with the accurate mass reference standard information to identify differences; and storing the accurate mass information from the second condition related to the second attribute in the library as a second list of targeted components, determining at least one quality attribute control limit related to the second list of targeted components, comparing the identity and quantity of the biological compound sample peaks and accurate mass information to the library of peaks and accurate masses related to the second list of targeted components, and determining if the at least one quality attribute control limit related to the second attribute has been exceeded.

The biological compound standard can be characterized in a single analysis using the chromatography-optical detector-mass spectrometry method. The preparation and data acquisition of the biological compound standard and the biological compound sample can be the same. The method can further include identifying a new component in the biological compound sample wherein the new component is determined not to be a component of a target compound stored in the library, and generating a notification for additional characterization of the new component in the biological compound standard, and for updating of the library. The new component can be more than 0.1 wt % of the biological compound sample.

In another embodiment, the present disclosure relates to a method of multiple attribute monitoring for a biological compound including testing a biological compound sample using a chromatography-optical detector-high resolution mass spectrometry method, wherein the testing includes (a) separating the biological compound sample using the chromatography-optical detector-high resolution mass spectrometry method, identifying and quantifying peaks generated by the optical detector and accurate masses generated by the high resolution mass spectrometry, (b) comparing the identity and quantity of the biological compound sample peaks and accurate mass information to a library of peaks and accurate masses related to a biological compound standard and one or more lists of targeted components, (c) for each accurate mass in the library, determining if a quality attribute control limit related to the one or more attributes has been exceeded, and (d) for each accurate mass not in the library, further analyzing peaks and accurate mass information from the chromatography-optical detector-high resolution mass spectrometry method and relating each accurate mass to an existing or new attribute, and store the accurate mass information related to the existing or new attribute in the library as a targeted component for the existing or new attribute. The method can further include determining at least one quality attribute control limit related to the accurate mass information related to the existing or new attribute.

In other embodiments, non-high resolution mass spectrometry can be used. The present disclosure relates to a method of multiple attributes monitoring for a biological compound including (i) characterizing a biological compound standard using a chromatography-optical detector-mass spectrometry method, wherein the characterization includes (a) separating the biological compound using the chromatography-optical detector and mass spectrometry method, identifying and quantifying peaks generated by the optical detector and masses generated by the mass spectrometry, storing the mass information in a library a mass reference standard information, (b) exposing the biological compound standard to a first condition related to a first attribute wherein the first condition induces at least one first chemical change to the biological compound standard, (c) separating the biological compound exposed to the first condition using the chromatography-optical detector-mass spectrometry method, identifying and quantifying peaks generated by the optical detector and masses generated by the mass spectrometry, comparing the masses from the first condition with the mass reference standard information to identify differences; and storing the mass information from the first condition related to the first attribute in the library as a first list of targeted components, (ii) determining at least one quality attribute control limit related to the first list of targeted compounds, (iii) testing a biological compound sample using the chromatography-optical detector-mass spectrometry method, wherein the testing includes, (a) separating the biological compound sample using the chromatography-optical detector-mass spectrometry method, identifying and quantifying peaks generated by the optical detector and masses generated by the mass spectrometry, and (b) comparing the identity and quantity of the biological compound sample peaks and mass information to the library of peaks and masses related to the biological compound standard and the first list of targeted components; and (c) determining if the at least one quality attribute control limit related to the first attribute has been exceeded.

The method can further include evaluating multiple attributes. The method can include exposing the biological compound standard to a second condition related to a second attribute wherein the second condition induces at least one second chemical change to the biological compound standard, separating the biological compound exposed to the second condition using the chromatography-optical detector-mass spectrometry method, identifying and quantifying peaks generated by the optical detector and mass generated by the mass spectrometry, comparing the masses from the second condition with the mass reference standard information to identify differences; and storing the mass information from the second condition related to the second attribute in the library as a second list of targeted components, determining at least one quality attribute control limit related to the second list of targeted components, comparing the identity and quantity of the biological compound sample peaks and mass information to the library of peaks and masses related to the second list of targeted components, and determining if the at least one quality attribute control limit related to the second attribute has been exceeded.

The methodology of the present disclosure provides advantages over the prior art, including providing fewer assays (e.g., a single assay) to monitor and test critical attributes of biological and complex samples. The complexity of these samples makes them more challenging to reproduce batch to batch, location to location and competitor to competitor. Confirming the proper production of a molecule, e.g., confirming the primary sequence, and identifying other attributes is important. Traditionally, such analysis required numerous conventional assays and long times to complete. The methodology of the present disclosure allows for improved productivity by reducing the number of assays, which also results in a savings of time and money. The direct monitoring of the sample allows for real-time analysis and is less prone to sample preparation errors.

In some instances, the use of high resolution mass spectrometry also improves the certainty of producing and confirming the biological and complex molecule. The generation of the high resolution mass spectrometry data also provides a more accurate description about the structural features of the molecule/compound. Such information can facilitate the development of bio-manufacturing processes by which the complex molecules are made. It can strengthen the measure of those quality attributes that are deemed to be critical to the efficacy and safety of the biological drug.

In addition, the implementation of the present methodology, and the information acquired from such a methodology can assist the uptake of the quality by design (QbD) philosophy promoted by FDA. The availability of both optical data (UV) and mass spectrometric data from a single assay can enable an approach/method which offers highly reproducible quantitative measurement for monitoring attributes and in the meantime provide unambiguous identity.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 shows an exemplary overview of the approach of the present disclosure to use common steps to both characterize and monitor standards/reference batches and samples.

FIG. 2 shows exemplary trastuzumab quality attributes as examined in Example 1.

FIG. 3 shows exemplary peptide mapping performed trastuzumab samples from Example 1.

FIG. 4 shows an exemplary targeted attribute list generation from Example 1.

FIG. 5 shows exemplary PepMap processing parameters for monitoring workflow from Example 1.

FIG. 6 shows exemplary 3D peak detection and componentization from improved MS quantification from Example 1.

FIG. 7 shows exemplary targeted monitoring for a glycopeptide (HC T26 G1F) from Example 1.

FIG. 8 shows exemplary trastuzumab HC glycopeptide extracted ion chromatograms (XICs) from Example 1.

FIG. 9 shows exemplary monitoring of glycopeptide variations with the accurate mass screening workflow from Example 1.

FIG. 10 shows an exemplary comparison of MS and UV responses versus percent oxidation (HC: T21 Oxidation—Stress Sample) from Example 1.

FIG. 11 shows an exemplary comparison of MS and UV responses versus percent oxidation (HC: T21 Oxidation (DTLMISR)) from Example 1

FIG. 12 shows exemplary percent oxidation results (HC T41 Ox WQQGNVFSCSVMHEALHNHYTQK) from Example 1.

FIG. 13 shows an exemplary comparison of MS and UV chromatograms (HC:T10 Deamidation NTAYLQMNSLR (N84D)) from Example 1.

FIG. 14 shows an exemplary comparison of deamidation results for aspartic and iso-aspartic (HC:T10 Deamidation) from Example 1.

FIG. 15 shows an exemplary method of setting limits and system suitability parameters from Example 2.

FIG. 16 shows exemplary chromatography system suitability checks from Example 2.

FIG. 17 shows exemplary HC lysine monitoring for both UV and MS from Example 2.

FIG. 18 shows an exemplary limit check analysis for lysine variant showing differences between two processes.

FIG. 19 shows an exemplary attribute centric report from Example 2.

FIG. 20 shows an exemplary flowchart of the methodology.

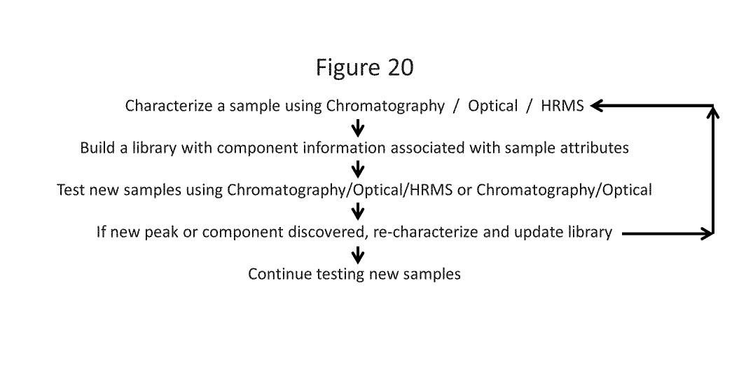

FIG. 21 shows another exemplary flowchart of the methodology.

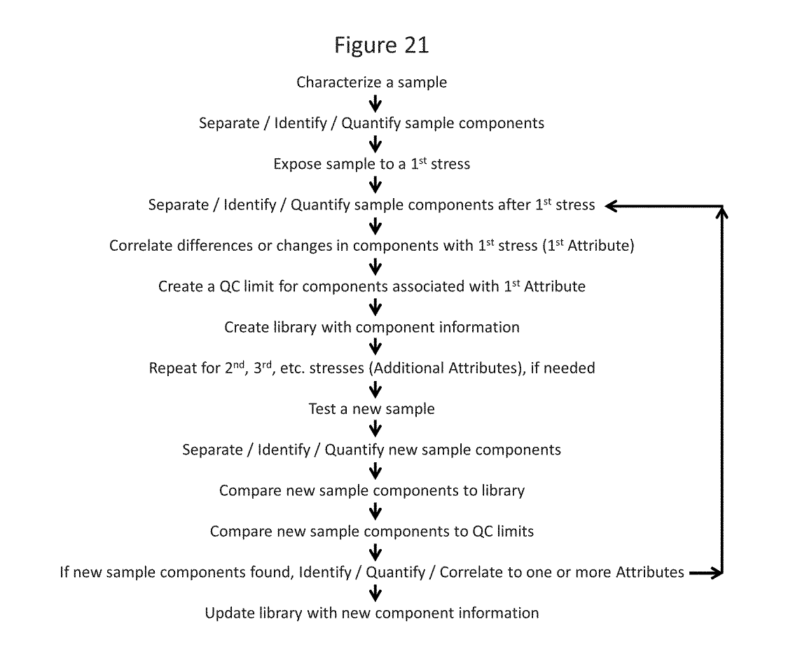

### DETAILED DESCRIPTION OF THE INVENTION

The present disclosure relates generally to a method of multiple attribute monitoring for biological and other complex compounds using a chromatography-optical detector-mass spectrometry method.

The methodology addresses some of the challenges of developing and reproducing large, biological and/or complex samples, e.g., compounds, molecules, though the development lifecycle, including from development to production to QC/QA and post approval. In the early stages of development, there are few compliance issues as the sample is characterized. In the monitoring phase, GxPs can apply as more information is known about the sample. Targeted analyses can be developed to ensure product production. In the release phase, high product knowledge of the sample is known and regulatory compliance is required. The methodology of the present disclosure can incorporate the high product knowledge into further characterization of the samples and generate focused monitoring assays to give discrete results with minimal interaction from a user.

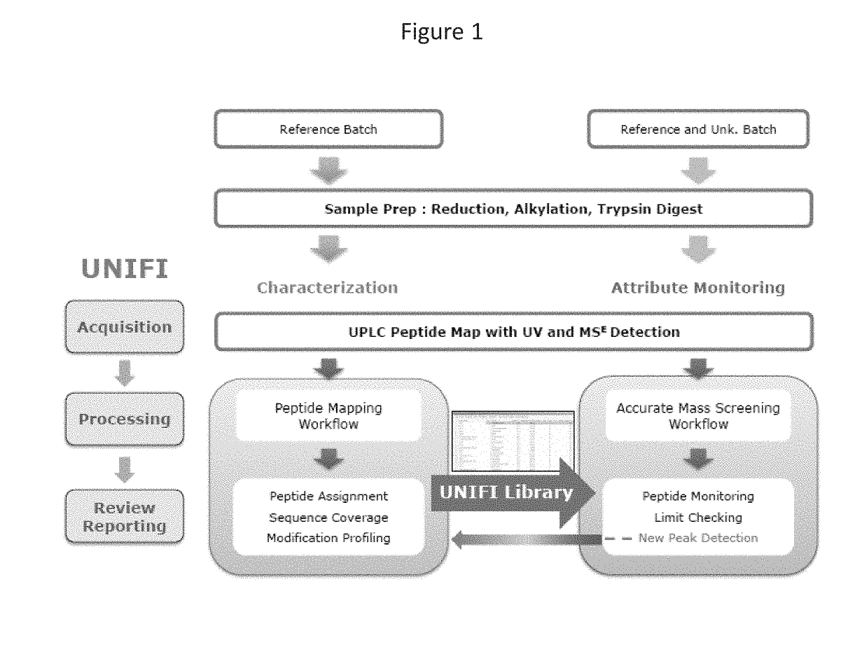

The characterization and monitoring assays can also use a common acquisition to enable efficient transition from characterization to monitoring. As provided in FIG. 1, the approach of the present disclosure includes common instruments and informatics platform between the characterization and monitoring assays. A common sample preparation and a common set of experimental conditions for acquisition of data can be used. This allows for two information processes to be used together.

In one embodiment, the present disclosure relates to a method of multiple attribute(s) monitoring for a biological compound including (i) characterizing a biological compound standard using a chromatography-optical detector-high resolution mass spectrometry method (e.g., LC/UV/MS), wherein the characterization includes (ia) separating the biological compound using the chromatography-optical detector and high resolution mass spectrometry method, identifying and quantifying peaks generated by the optical detector and accurate masses generated by the high resolution mass spectrometry, storing the accurate mass information in a library as accurate mass reference standard information, (ib) exposing the biological compound standard to a first condition related to a first set of attributes wherein the first condition induces at least one first chemical change to the biological compound standard, (ic) separating the biological compound exposed to the first condition using the chromatography-optical detector-high resolution mass spectrometry method, identifying and quantifying peaks generated by the optical detector and accurate masses generated by the high resolution mass spectrometry, comparing the accurate masses from the first condition with the accurate mass reference standard information to identify component and their differences; and storing the accurate mass information from the first condition related to the first attribute in the library as a first list of targeted components, (ii) determining at least one quality attribute control limit related to the first list of targeted compounds and (iii) testing a biological compound sample using the chromatography-optical detector-high resolution mass spectrometry method, wherein the testing includes (iiia) separating the biological compound sample using the chromatography-optical detector-high resolution mass spectrometry method, identifying and quantifying peaks generated by the optical detector and accurate masses generated by the high resolution mass spectrometry, and (iiib) comparing the identity and quantity of the biological compound sample peaks and accurate mass information to the library of peaks and accurate masses related to the biological compound sample and the first list of targeted components, and (iiic) determining if the at least one quality attribute control limit related to the first attribute has been exceeded.

The method of the present disclosure can be used for multiple attribute monitoring of any biological or complex sample, molecule or compound (referred to herein as “standard,” “sample” or “biological sample” but inclusive of other complex molecule(s)). For example, the molecule can be biopharmaceutical product or biosimilar. The molecule can be a single molecule. In some embodiments, the complex sample can be biological product-by-process containing one or more molecules or compounds. Examples of biological or complex samples, molecules or compounds include, but are not limited to, peptides (synthetic and recombinant), proteins and their derivatives (e.g. protein conjugates), oligonucleotides and its analogs, oligosaccharides. Exemplary biological molecules include trastuzumab and infliximab.

The methodology can be used to characterize a reference standard or sample to establish or define a set of attributes for monitoring. The characterization can include exposing the reference standard or sample to one or more known conditions or stresses to induce a chemical change. The components associated with or indicative of the chemical change can be identified and used as targeted components associated with the condition or stress. Characterization can help define the structure-function relationship, and identify potential pathways, of the standards or sample. The targeted components and the associated attributes can be stored in a library to be used to test additional standards and samples. Appropriate controls can be placed on the targeted components to provide a measure of quality control. The controls can be related to GxP or other regulatory quality control requirements. The methodology can be used to monitor and further analyze samples in real time for both research and quality control purposes.

The characterization and testing of the biological or complex sample, molecule or compound can be performed using a chromatography-optical detector-mass spectrometry (e.g., HRMS) system. The chromatography can be any chromatography technique that can efficiently separate the biological or complex sample, molecule or compound so that quality attributes can be effectively monitored. Examples of chromatography techniques include, but are not limited to, normal phase chromatography, reversed phase chromatography, carbon dioxide based chromatography, size exclusion chromatography, ion exchange chromatography, hydrophilic interaction liquid interaction chromatography, hydrophobic interaction chromatography, affinity chromatography, and combinations thereof. The separation can also be other separation based technique such as capillary electrophoresis, isotachophoresis, electrochromatography, and the like. The chromatography system can be an ACQUITY UPLC® from Waters Technologies Corporation.

The optical detector can be any optical detector that can operate in-line with, or is compatible with, the chromatography technique and the mass spectrometer. Examples of optical detectors include, but are not limited to, a (Reflective Index) detector, a MALS (Multi-angle light scattering) detector, a ELSD (evaporated light scattering detection) detector, a FLR (fluorescence) detector, a IR (Infrared) detector, a PDA detector and a UV/VIS detector, and combination thereof.

The methodology of the present disclosure can be used with any mass spectrometer configured to monitor various attributes, such as any attribute having an identifiable mass within the instrument's mass resolution and range. The mass spectrometer can be a high resolution mass spectrometer, e.g., time of flight mass spectrometer, or a non-high resolution mass spectrometer, e.g., a quadrupole mass spectrometer. The mass spectrometer can be a single quadrupole MS detector, such as an ACQUITY QDa® from Waters Technologies Corporation. The mass spectrometer can be operated in data dependent or data independent acquisition mode.

The unit mass resolution of the mass spectrometer, e.g., full width at half maximum, can be about 0.001, 0.005, 0.01, 0.05, 0.1, 0.5, 1, 5 or about 10 Daltons. These values can be used to define a range, such as about 0.1 to about 1 Daltons. The mass range of the mass spectrometer can be about 50, 100, 200, 300, 400, 500, 600, 700, 800, 900, 1000, 1100, 1200, 1300, 1400, 1500, 1600, 1700, 1800, 1900 or about 2000 m/z. These values can be used to define a range, such as about 50 to about 100 m/z, or about 50 to about 2000 m/z.

The mass spectrometer, e.g. ACQUITY QDa® from Waters Technologies Corporation, can be used to screen synthetic oligonucleotide samples for oligo identification and purity and can have higher throughput requirements. The ACQUITY QDa® can also be useful in the monitoring of CDR (complimentary domain region) peptides. These particular peptides govern whether an antibody will interact with its specific antigen, e.g., the CDR peptides for trastuzumab which can be monitored the ACQUITY QDa®. A chromatogram can be extracted which represents the masses of each of the CDR containing peptides within a peptide map. The mass accuracy can be about or less than about 0.05, 0.1, 0.2, 0.3, 0.4, 0.5, 0.6, 0.7, 0.8, 0.9, 1 or about 1.5 Dalton. These values can be used to define a range, such as about 0.1 to about 1 Daltons. The dynamic range can be about 3, or can be greater than about 3 orders of magnitude.

The high resolution mass spectrometer can be any high resolution mass spectrometer configured to determining an accurate mass for each peak, component, ion, fragment, etc. as well as being configured to determine the structure of each, e.g., structural elucidation. The high resolution mass spectrometer can provide in depth oligonucleotide characterization and sequence confirmation. The high resolution mass spectrometer can generate accurate masses measured in mass-to-charge ratio (less than about 2, 3, 4, 5, 6, 7, 8, 9 or about 10 ppm on average), and can produce a resolved isotope distribution for compounds with a molecule weight of less than about 5000, 6000, 7000, 8000, 9000, 10000, 12000 or about 15000 Dalton. Examples of high resolution mass spectrometers include, but are not limited to, a Tof, FT-ICR (Fourier transform ion cyclotron resonance mass spectrometry) or an orbitrap. The high resolution mass spectrometer can be a Vion™ IMS QTof mass spectrometer from Waters Technologies Corporation.

The method also includes identifying and quantifying peaks generated by the optical detector and accurate masses, as well as other physiochemical properties related information, generated by the mass spectrometry (e.g., HRMS). The determination of these peaks and masses can create a baseline of peaks and masses (e.g., accurate masses) for the reference standard compound standard, or sample.

The mass spectrometer can be any MS instrument capable of providing accurate mass determination for both parent and daughter peaks, and capable of data independent acquisition. Data independent acquisition provides a further increase to the specificity of fragmentation for identification purposes. The present disclosure incorporates by reference U.S. Pat. Nos. 6,717,130 and 6,586,727 which fully describe a mass spectrometer having data independent acquisition.

Data independent mode can be used, for example, for structural elucidation of the sample, compound, molecule, components, ions, etc. In data independent mode, the mass spectrometer uses both high and low energy fragmentation mass spectrum of a ion or component which allows for cross-referencing a set of peaks in the low energy fragmentation mass spectrum with a set of peaks in the high energy fragmentation mass spectrum that are substantially similar. From the cross-referenced low and high energy data, the chemical structure of the component can be identified. The high energy fragmentation mass spectrum and a low energy fragmentation mass spectrum of a ion, or component, can be generated using data independent methods, such as MS^{E} or HDMS^{E}.

Data independent acquisition involves the use of a collision cell that alternates low and high collision energy before MS detection. The low-energy spectra can contain ions primarily from unfragmented precursors, while the high-energy spectra can contain ions primarily from fragmented precursors. The alternating energy protocol can collect spectra from the same precursor in two modes, a low-energy mode and a high-energy mode.

The mass spectrometer can include a collision cell operable in a first mode wherein at least a portion of said ions are fragmented to produce daughter ions, and a second mode wherein substantially less ions are fragmented, a mass analyzer, and a control system which, in use, repeatedly switches the collision cell back and forth between the first and the second modes. In the first mode, the control system can arrange to supply a voltage to the collision cell selected from the group consisting of ≧15V; ≧20V; ≧25V; ≧30V; ≧50V; ≧100V; ≧150V; and ≧200V. In the second mode, the control system can arrange to supply a voltage to said collision cell selected from the group consisting of ≦5V; ≦4.5V; ≦4V; ≦3.5V; ≦3V; ≦2.5V; ≦2V; ≦1.5V; ≦1V; ≦0.5V; and substantially 0V. These sets of values can also be used to define a range, such as between about 20 and 30 V, or about 5 and 3 V.

The control system can automatically switch the collision cell between the two modes in a sufficiently short time to allow at least one of the analytes, precursors or ions to be exposed to each mode. The control system can automatically switch the collision cell between the two modes every about 5, 4, 3, 2.5, 2, 1.5, 1, 0.9, 0.8, 0.7, 0.6, 0.5, 0.4, 0.3, 0.2, 0.1 or 0.05 seconds. These values can also be used to define a range, such as about 5 to about 0.5 seconds.

The output of the instrument using data independent acquisition is an inventory, or list, of precursor and fragment ions, each ion can be described by its retention time, drift time, isolated/selected m/z, determined m/z, intensity, etc., or combinations thereof. The low-energy mode can produce a list of ions that contains primarily unfragmented precursor ions. The high-energy mode can produce a list of ions that contains primarily fragmented precursor ions. As described in U.S. Pat. Nos. 6,717,130 and 6,586,727, the parent-daughter peaks can be grouped upon these descriptions, e.g., retention time and/or drift time. These groupings can assist in structural elucidation.

The method includes storing the accurate mass information in a library as accurate mass reference standard information. The information can be stored, or retained, in an electronic form on a computer or other similar electronic storage device. The accurate mass information can include parent and daughter mass information and ratios, retention time, drift time, collision cross-section areas, isolated/selected m/z, determined m/z, intensity, etc.

In some instances, the storing of the information can be selective, which means that only subset of the information from characterization is “stored” in a library for monitoring assay. From the characterization step (process), information can be obtained on many attributes but only some (a subset) of the attributes can be monitored in the monitoring process (step). The selection of which attributes to be monitored depends on if the attributes are important to the compound's properties (e.g. safety and efficacy). Pre-defined “threshold” values on these attributes can, or may not, be stored within the library. Information such as accurate mass of parent and product ions, their retention time, drift time collisional cross-section areas can, and usually is, stored in the library.

The library can be a scientific library, which means the library can contain information pertaining to the physicochemical properties of the compounds/samples. It can also be archived, backed up, searched and retrieved, and updated as needed. The library can be accessible by the instrumentation and software. It can be used with further analyses to compare against to identify components. The library can also be updated with new information from the further analyses. The library can be a unique library for the sample being analyzed. The library can contain only the accurate mass information, etc., related to the sample and its associated attributes. In one embodiment, the software can enable a user to create a custom scientific library containing the targeted components, e.g., targeted peptides, with specific attributes. The library can be used as part of the data processing to search and quantify these targeted components. The library can be user developed or developed specific for a certain compound.

The methodology can utilize software that can control the chromatography-optical detector-mass spectrometry system. The software can also automate the identification and quantification of the components including analysis of the UV peaks, ions, mass information, accurate mass information, etc. The software can also contain or access the library and other relational databases. The software can coordinate the conditions, attributes and components such that the appearance of one or more components in a sample can be attributed to one or more conditions or attributes. The software can be UNIFI® or EMPOWER®, both commercially available from Waters Technologies Corporation.

The software can provide a comprehensive platform for accurate mass measurement, data processing and reporting. The characterization and testing of the standards/samples and the acquisition and processing of the information can be performed within the same platform. The use of the same platform can allow accurate identification of a modification, such as a post-translation modification, e.g., protein glycosylation, to be coupled with fast and accurate analyses. The software can provide the tools needed for the deployment of the platform in a GxP environment, such as audit trail and electronic signature. It can have the capability to automatically achieve (back up) the data collected from the analysis, and offer the ability to search the data saved.

These data analysis software can interface with MASSLYNX™, and provide automated data analysis and reporting capabilities, including automated deconvolution and purity analysis of oligonucleotide mass spectra (both average mass and high resolution data), and the ability to support high throughput workflows.

The methodology can provide a quantitative and qualitative comparison of a reference biological compound with the compound that has undergone, been exposed to, is generated from, etc. a stressed condition, a manufactory process change, or similar. The changes observed can be correlated to the compound's quality attributes to that condition. Monitoring biological sample compound for the attributes can impact its safety or efficacy of the compound, e.g., such as a therapeutic drug molecule.

The biological compound standard, or sample, can be exposed to a first condition related to a first attribute wherein the first condition induces at least one first chemical change to the biological compound standard. The condition, e.g., first condition, can be an experimental condition used to simulate a change or modification of the biological compound, such as a therapeutical protein or peptide. The change can include a manufactory or simulated manufactory processing change. The condition can be designed to mimic changes of biological samples (e.g., therapeutic proteins) caused by various manufactory process conditions or sample stress conditions for stability testing. Example of conditions can include changes in pH, temperature, light in product storage, changes in formulation, changes in feeding material and cell lines in a cell culture incubation.

The change or modification of the sample can be a chemical change. The change can be an addition or loss of a functional group. The change can be an increase or decrease in the amount or relative amount of the compound. The change should be a change that can be determined and measured, either directly or indirectly, by the chromatography-optical detector-mass spectrometer system (e.g., HRMS). Each condition can induce at least one change. Each condition can also induce two or more changes in the compound. One or more of the changes can be correlated to, and associated with, one or more attributes of the sample.

In one embodiment, the conditions tested to stimulate modifications in the biological sample can be related to an attribute selected from the group consisting of deamidation assessment, isomerization assessment, glycation assessment, high mannose assessment, methionine oxidation assessment, signal peptide assessment, unusual glycosylation assessment, CDR tryptophan degradation assessment, non-consensus glycosylation assessment, n-terminal pyroglutamate assessment, n-terminal truncation, c-terminal lysine assessment, galactosylation assessment, host cell protein assessment, mutations/misincorporations assessment, hydroxylysine assessment, thioether assessment, non-glycosylated heavy change assessment, fucosylation assessment, residual protein A assessment and identity assessment.

In one embodiment, the methodology can include a data processing step that focuses on characterization wherein all of the critical attributes of a biological sample are identified. These critical attributes, and the associated peaks, accurate masses, ions, etc. can be stored in the library. The methodology also relates to a second data processing step wherein a targeted search can be conducted to identify and quantify the peaks, accurate masses, ions, e.g., peptide ions, associated with the attributes. In some instances, the data processing steps can be performed on the same data set.

Critical quality attributes can be those attributes which are important to the drug's safety and/or efficacy. Typically there are a lot attributes that can be identified for any molecule/compound/sample. Only some of these can be “critical.” For example, there are many glycosylation structures typically identified for a molecule. All of the glycosylation structures are “attributes” associated with the molecule, but only a few of the glycosylation structures are important to the function or immunogenicity of the molecule. Others are there simply because how the molecule is made.

The method can include separating the biological compound exposed to the first condition using the chromatography-optical detector-mass spectrometry method. The separation can provide for baseline resolution for one or more of the sample components. The separation can also resolve the sample into groups of components or peaks over the elution period. The method can identify and quantify peaks generated using an optical detector and can identify and quantitate masses generated by the mass spectrometry.

The masses separated, identified and/or quantitated from the first condition can be compared with the mass reference standard information to identify differences or changes between the two. The differences or changes can be a chemical change, an increase or decrease in a component, ion, ion ratio, etc. The mass information from the first condition related to the first attribute and the differences can be stored as a first list of targeted components. The targeted components, including the first list of targeted components, can be characterized by retention time, neutral mass, confirmatory fragments, drift time, collision cross section area or combinations thereof.

The method can include determining at least one quality attribute control limit related to one or more targeted components, e.g., the first list of targeted components. A control limit typically reflects how much of the changes of the attributes is due to natural variation of production process. The establishment of the quality control (QC) limit can be the result of prior experimentation and testing processes where the normal (acceptable) or unacceptable values are acquired. The control limit can include a specification limit. The control limit can be percent change, appearance or disappearance of a peak, component, ion, ratio, etc. that indicates that a significant difference. For example, an oxidation by-product can be formed over time. A control limit can be an amount, or change in the amount, of the oxidation by-product. Exceeding the control limit indicates a potential problem associated with that attribute. Determining a control limit for an attribute can include testing one or more samples to understand the nature of the targeted components related to the attribute.

The characterization to determine the target components for each attribute and respective control limits can be performed using a number of different conditions associated with a number of different attributes. The characterization can be performed in a single analysis, can be performed separately for each condition, or combinations thereof.

Once an initial characterization is completed, testing of a biological compound sample can be performed using the same, or similar, chromatography-optical detector-mass spectrometer system. The testing can include separating the biological compound sample using the chromatography-optical detector-mass spectrometry method and identifying and quantifying peaks generated by the optical detector and masses (e.g., accurate) generated by the mass spectrometry (e.g., HRMS). The identified and quantified peaks and mass information of the biological compound sample can be compared to the library of peaks and masses related to the biological compound standard and the first list of targeted components. The comparison can be used to determine if a quality attribute control limit, such as the one related to the first attribute, has been exceeded.

The system includes collecting both UV and MS data. Including identifying and/or quantifying with both UV and MS data provides users with additional information of the analytes. The elution time of the UV peaks, the elution time of the component peaks in mass spectrometry chromatogram, or both can be adjusted to match. The software can time align the optical data and mass spectrometry data, such as from two separate data channels of the same analysis. The components identified from the mass spectrometry data can also get assigned and quantify by the optical data. The optical data can be used for quantitation of one or more components and the MS data can be used for mass identification. An optical detector can provide more accurate and/or more precise quantitation of select components. The use of an optical detector can decrease the percent difference of the system measurement by about 5%, 10, 15, 20, 25, 30, 40 or about 50%. These values can be used to define a range, such as about 10% to about 30%. The use of an optical detector can decrease the standard deviation or standard error of the system measurement by about 5%, 10, 15, 20, 25, 30, 40 or about 50%. These values can be used to define a range, such as about 5% to about 20%. An optical detector can also provide better system suitability. For example, quantitation with an optical detector, e.g. UV, can remove ionization variability in the results and provides more reproducible results. In some embodiments, the method can further include determining if a UV peak comprises two or more co-eluting components using the mass spectrometry data. For UV peaks having two or more co-eluting components, these peak can be excluded from the testing steps, e.g., comparing steps, etc., of the biological compound sample. In some instances, the method can identify peaks that can be separated and quantitated using only UV data. In such instances, the method can be used or transferred to a system or laboratory having traditional less expensive chromatography-optical detector capabilities.

The method can further include evaluating multiple attributes. For example, the method can include exposing the biological compound standard to a second condition related to a second attribute wherein the second condition induces at least one second chemical change to the biological compound standard, separating the biological compound exposed to the second condition using the chromatography-optical detector-high resolution mass spectrometry method, identifying and quantifying peaks generated by the optical detector and accurate mass generated by the high resolution mass spectrometry, comparing the accurate masses from the second condition with the accurate mass reference standard information to identify differences; and storing the accurate mass information from the second condition related to the second attribute in the library as a second list of targeted components, determining at least one quality attribute control limit related to the second list of targeted components, comparing the identity and quantity of the biological compound sample peaks and accurate mass information to the library of peaks and accurate masses related to the second list of targeted components, and determining if the at least one quality attribute control limit related to the second attribute has been exceeded.

In another embodiment, the method can include exposing the biological compound standard to a second condition related to a second attribute wherein the second condition induces at least one second chemical change to the biological compound standard, separating the biological compound exposed to the second condition using the chromatography-optical detector-mass spectrometry method, identifying and quantifying peaks generated by the optical detector and mass generated by the mass spectrometry, comparing the masses from the second condition with the mass reference standard information to identify differences; and storing the mass information from the second condition related to the second attribute in the library as a second list of targeted components, determining at least one quality attribute control limit related to the second list of targeted components, comparing the identity and quantity of the biological compound sample peaks and mass information to the library of peaks and masses related to the second list of targeted components, and determining if the at least one quality attribute control limit related to the second attribute has been exceeded.

The number of attributes can include 1, 2, 3, 4, 5, 6,7 , 8, 9, 10, 20, 30, etc. These values can be used to define a range, such as about 1 to about 20.

The characterization for the biological compound standard relative to one or more attributes can be performed in a single analysis, or in less analyses than the number of attributes using the chromatography-optical detector-mass spectrometry method. Multiple attributes can be characterized and tested on a single analysis.

The preparation and data acquisition of the biological compound standard and the biological compound sample can be the same, or substantially the same. By keeping the similarities between the preparation and data acquisition, the method can further include identifying a new component in the biological compound sample wherein the new component is determined not to be a component of a target compound stored in the library. The discovery of a new component can generate a notification for additional characterization of the new component. Once characterized, the library can be updated with the new component, e.g., mass information or accurate mass information, as being associated to the appropriate attribute. In some instances, a new component is one that is present in more than 0.05 wt %, 0.1, 0.5, 1, 5 or about 10 wt %. These values can be used to define a range, such as about 0.1 to about 0.5 wt %.

The methodology can be used with an existing library containing one or more target components associated with one or more attributes of the biological or complex sample. The methodology can be used to test and/or monitor the attribute(s), and can also be used to enhance, add or refine the library by adding new target components to the library based on the analysis or further analyses. In some instances, the acquisition of the sample is performed on a chromatograph-optical detector-mass spectrometer such that the analysis of a new component can be performed without additional analysis being run. The existing UV and MS data collected can be re-analyzed for identifying the new component and relating it to a new or existing attribute.

In another embodiment, the present disclosure relates to a method of multiple attribute monitoring for a biological compound including testing a biological compound sample using a chromatography-optical detector-high resolution mass spectrometry method, wherein the testing includes (a) separating the biological compound sample using the chromatography-optical detector-high resolution mass spectrometry method, identifying and quantifying peaks generated by the optical detector and accurate masses generated by the high resolution mass spectrometry, (b) comparing the identity and quantity of the biological compound sample peaks and accurate mass information to a library of peaks and accurate masses related to a biological compound standard and one or more lists of targeted components, (c) for each accurate mass in the library, determining if a quality attribute control limit related to the one or more attributes has been exceeded, and (d) for each accurate mass not in the library, further analyzing peaks and accurate mass information from the chromatography-optical detector-high resolution mass spectrometry method and relating each accurate mass to an existing or new attribute, and store the accurate mass information related to the existing or new attribute in the library as a targeted component for the existing or new attribute. The method can further include determining at least one quality attribute control limit related to the accurate mass information related to the existing or new attribute.

In another embodiment, the present disclosure relates to a method of multiple attribute monitoring for a biological compound including testing a biological compound sample using a chromatography-optical detector-mass spectrometry method, wherein the testing includes (a) separating the biological compound sample using the chromatography-optical detector-mass spectrometry method, identifying and quantifying peaks generated by the optical detector and masses generated by the mass spectrometry, (b) comparing the identity and quantity of the biological compound sample peaks and mass information to a library of peaks and masses related to a biological compound standard and one or more lists of targeted components, (c) for each mass in the library, determining if a quality attribute control limit related to the one or more attributes has been exceeded, and (d) for each mass not in the library, further analyzing peaks and mass information from the chromatography-optical detector-mass spectrometry method and relating each mass to an existing or new attribute, and store the mass information related to the existing or new attribute in the library as a targeted component for the existing or new attribute. The method can further include determining at least one quality attribute control limit related to the mass information related to the existing or new attribute.

In another embodiment, the sample stressing which can be used to generate a positive control to mimic the conditional changes can be omitted when, for example, one or more of the conditional changes, or attributes, are known. In another embodiment, the present disclosure relates to a method of multiple attribute(s) analysis monitoring for a biological compound including (i) characterizing a biological compound standard using a chromatography-optical detector-high resolution mass spectrometry method (e.g., LC/UV/MS), wherein the characterization includes (ia) separating the biological compound using the chromatography-optical detector and high resolution mass spectrometry method, identifying and quantifying peaks generated by the optical detector and accurate masses generated by the high resolution mass spectrometry, storing the component information including accurate mass, retention time, fragmentation, etc. in a library as accurate mass reference standard information, (ii) exporting the one or more attribute list from the library to a monitoring workflow and determining at least one quality attribute under monitoring workflow and (iii) testing a biological compound sample using the chromatography-optical detector-high resolution mass spectrometry method, wherein the testing includes (iiia) separating the biological compound sample using the chromatography-optical detector-high resolution mass spectrometry method, identifying and quantifying peaks generated by the optical detector and accurate masses generated by the high resolution mass spectrometry, and (iiib) comparing the identity and quantity of the biological compound standard peaks and accurate mass information to the library of peaks and accurate masses related to the biological compound sample and the first list of targeted components, and (iiic) determining if the at least one quality attribute control limit related to the first attribute has been exceeded.

In another embodiment, the present disclosure relates to a method of multiple attribute(s) analysis monitoring for a biological compound including (i) characterizing a biological compound standard using a chromatography-optical detector-mass spectrometry method (e.g., LC/UV/MS), wherein the characterization includes (ia) separating the biological compound using the chromatography-optical detector and mass spectrometry method, identifying and quantifying peaks generated by the optical detector and masses generated by the mass spectrometry, storing the component information including mass, retention time, fragmentation, etc. in a library as mass reference standard information, (ii) exporting the one or more attribute list from the library to a monitoring workflow and determining at least one quality attribute under monitoring workflow and (iii) testing a biological compound sample using the chromatography-optical detector-mass spectrometry method, wherein the testing includes (iiia) separating the biological compound sample using the chromatography-optical detector-mass spectrometry method, identifying and quantifying peaks generated by the optical detector and masses generated by the mass spectrometry, and (iiib) comparing the identity and quantity of the biological compound standard peaks and mass information to the library of peaks and masses related to the biological compound sample and the first list of targeted components, and (iiic) determining if the at least one quality attribute control limit related to the first attribute has been exceeded.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

### Example 1

### Trastuzumab Stress Study

This study uses peptide mapping of trastuzumab to show the characterization and quality control testing of the present disclosure. Trastuzumab is a recombinant DNA-derived humanized monoclonal antibody that selectively binds with high affinity in a cell-based assay to the extracellular domain of the human epidermal growth factor receptor 2 protein, HER2. The antibody is an IgG₁ kappa that contains human framework regions with the complementarity-determining regions of a murine antibody (4D5) that binds to HER2. Trastuzumab can be produced by a mammalian cell (e.g., Chinese hamster ovary or CHO) suspension culture in a nutrient medium containing the antibiotic gentamicin.

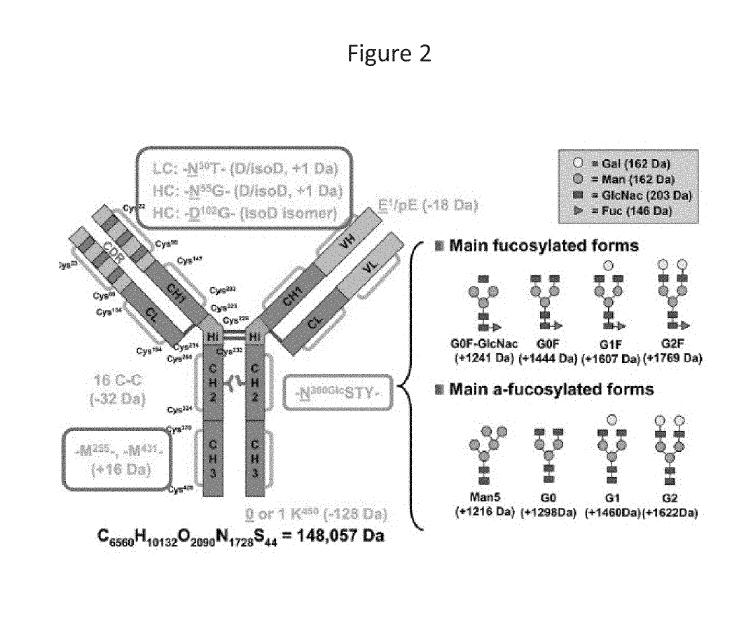

Select critical attributes of trastuzumab were characterized and tested using LC/UV/HRMS. Trastuzumab was selected, in part, because many features about trastuzumab that are known, including the portions that undergo deamidation and its general resistance to glycosylation (See FIG. 2). Trastuzumab samples were reduced and alkylated prior to a 60 minute trypsin digestion. Each digest contained an internal standard of LeuEnk, 5 μM. An ACQUITY UPLC® H-Class Bio liquid chromatography system from Waters Technologies Corporation was equipped with a CSH 2.1×100 mm, 1.7μ column. An injection volume of 10 μL of digest was used. A 120 minute gradient from 3-33% ACN (0.1% FA) was used at a flow rate of 0.2 mL/min, column temperature 65° C. UV detection was undertaken at 215 nm. A Vion™ IMS QTof mass spectrometer from Waters Technologies Corporation was used in LCMS^{E} acquisition mode (i.e., data independent mode). UNIFI® 1.8 (SR2) software from Waters Technologies Corporation was used to control acquisition, processing and reporting.

The trastuzumab samples were tested under stressed and unstressed conditions. The two stressed samples included an alkaline stress wherein a sample was held at pH 9.0, 37° C. for up to 2, 4 and 7 days. An oxidation stress was also performed wherein a sample was exposed to H₂O₂ for 24 hours at room temperature at concentrations (v/v) of 0.003%, 0.01% and 0.015%. A total of four control samples were tested and two samples for each stress condition were tested.

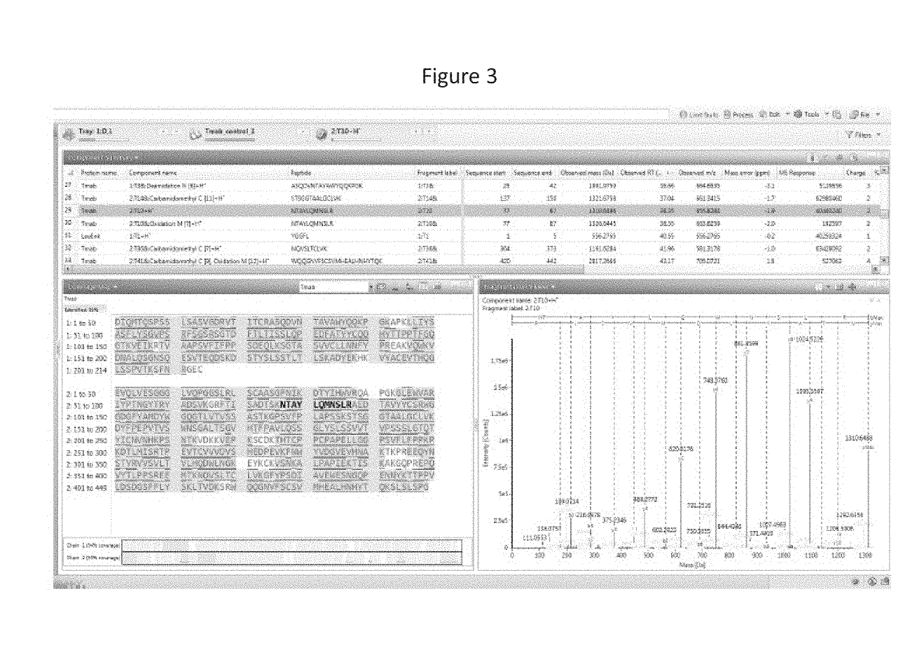

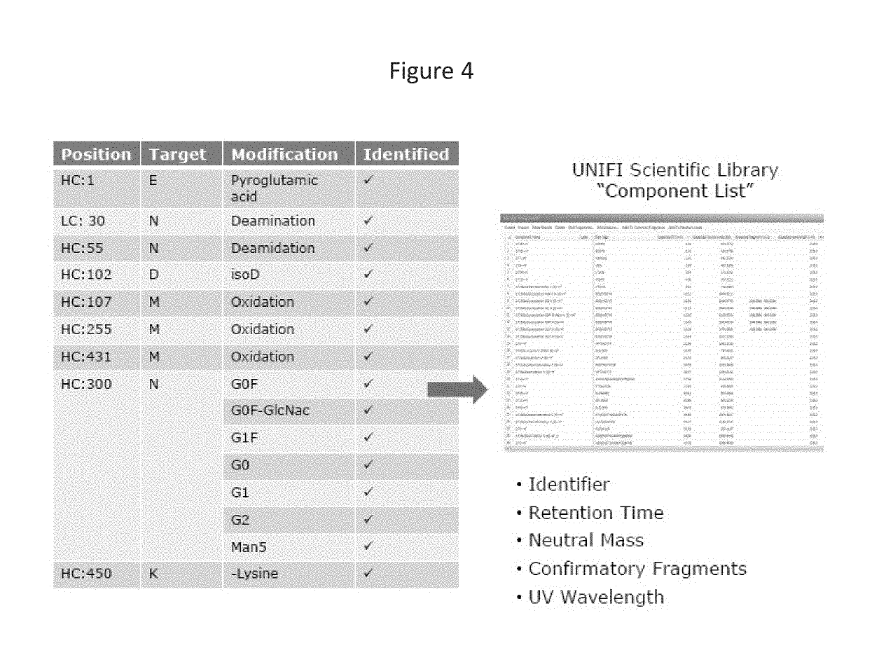

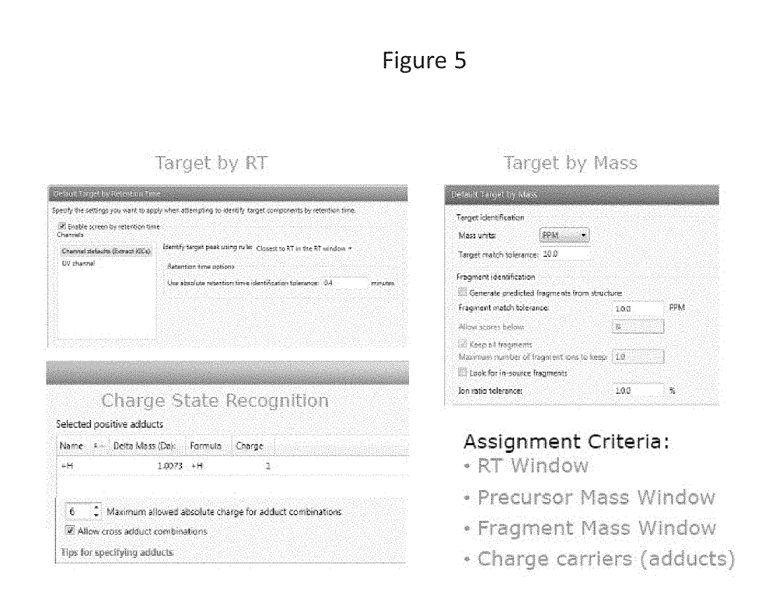

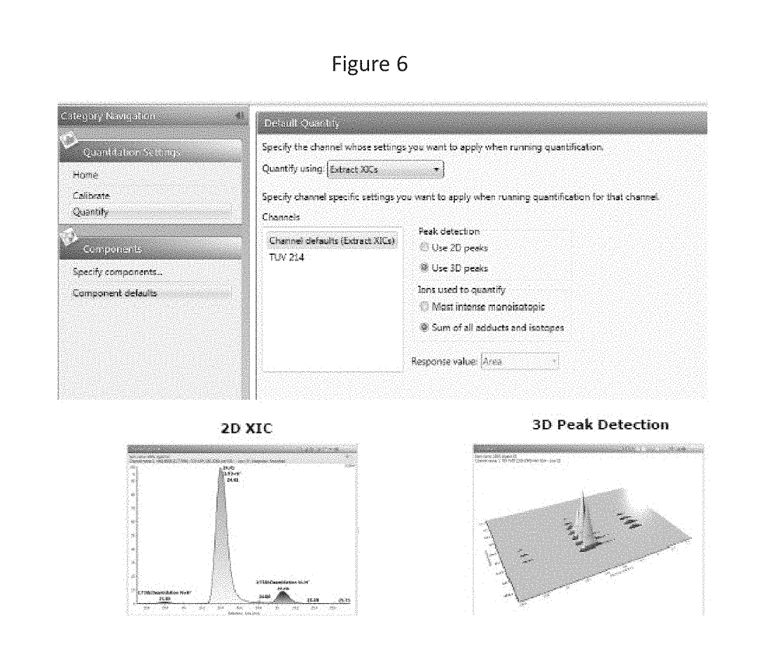

The mass data was analyzed using standard bio-informatic peptide peak assignments. FIG. 3 shows peptide mapping for the trastuzumab sample. The mass data was analyzed to determine the target component(s) associated with each modification(s), e.g., deamidation. The list of target components was identified and stored in a component library. Additional information for each target component was also stored, such as identifier, retention time, neutral mass, confirmatory fragments, if needed, and UV signal. FIG. 4 shows a partial targeted attribute list for trastuzumab. The mass data was then processed using accurate mass screening workflow in a semi-targeted mode. For each component, the following criteria were set: retention time window, precursor mass window to identify the component, fragment mass window, if needed, and charge carriers. Some of the specific charge carriers identified were used for quantification. FIG. 5 shows an example of the PepMap processing software screen display. FIG. 6 shows the 3D peak detection and componentization for MS quantification.

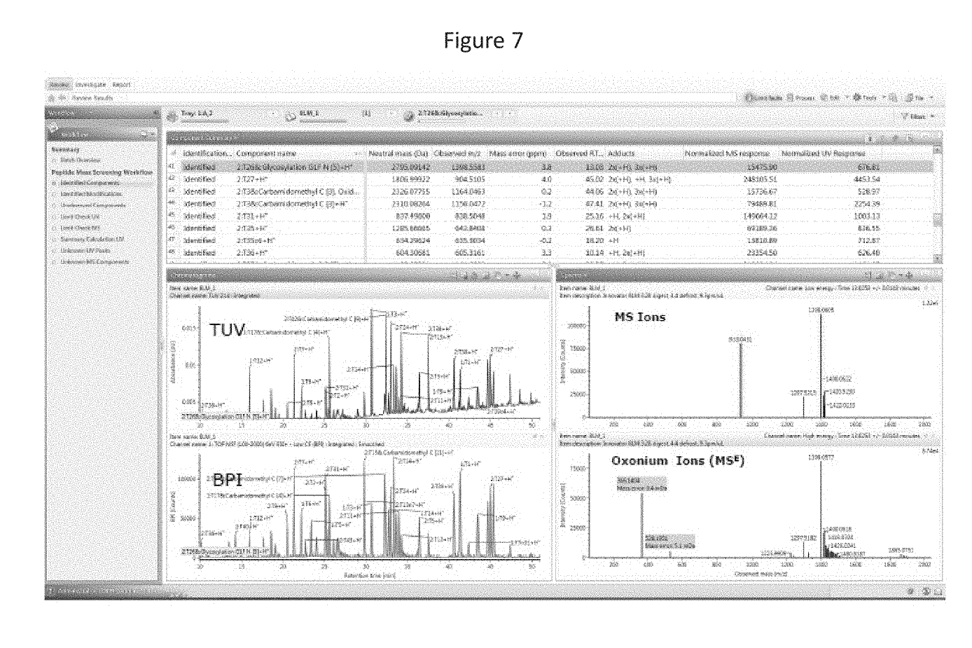

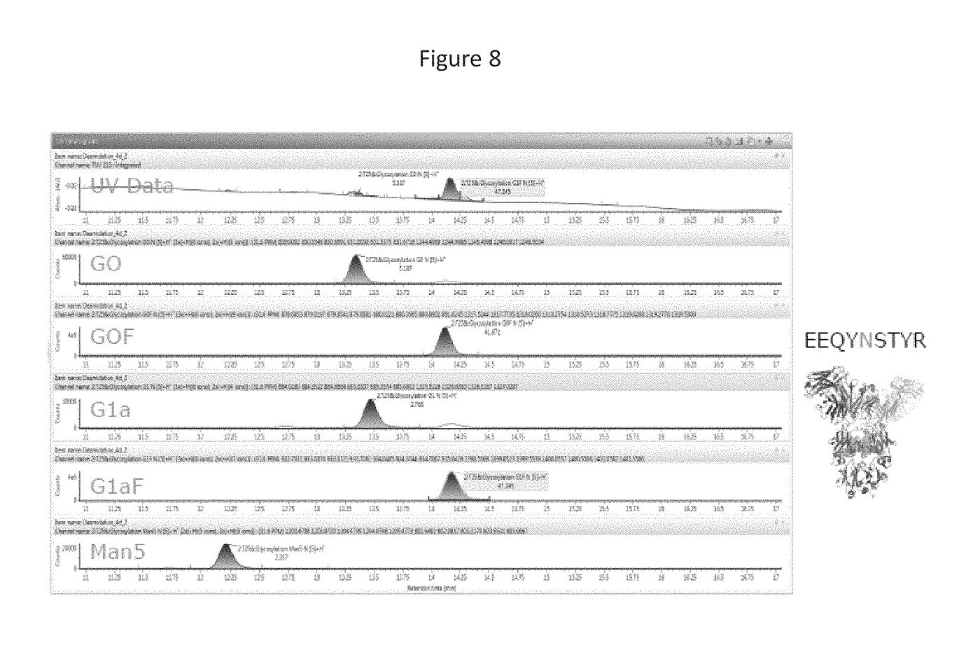

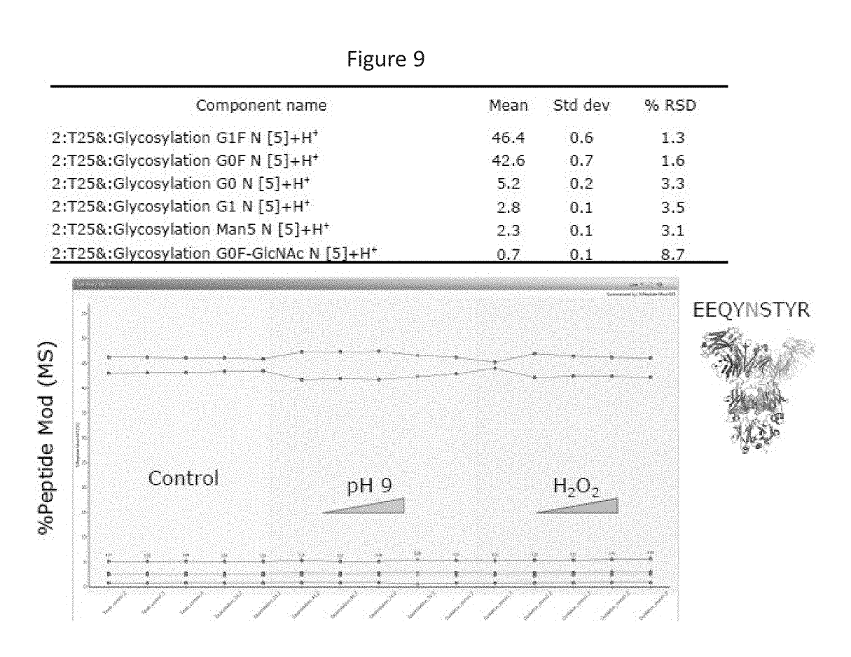

Targeted screening for a target component, e.g., the glycopeptide HC: T26 G1F, was performed. FIG. 7 shows TUV and MS data windows. The m/z values from two charge states of ions from the mass data matched with the library values for HC: T26 G1F. The identification of HC: T26 G1F component was further confirmed by the oxonium ions in the mass data. The other glyco variants were identified and quantified similarly. FIG. 8 shows the extracted ion chromatograms (XICs) for several trastuzumab HC glycopeptides for quantification purpose. A summary of the data from the accelerated study is shown in FIG. 9, illustrating the quantitation results when the accurate mass screening workflow was applied for monitoring glycopeptide variations. The components were determined with good reproducibility, such that the % RSD values were less than 2% for major peaks and less than 10% for minor peaks. The glycoforms showed good stability in both stressed conditions, i.e., high pH and oxidation. As shown in FIG. 9, only minor systematic differences in the two highest abundance components were observed.

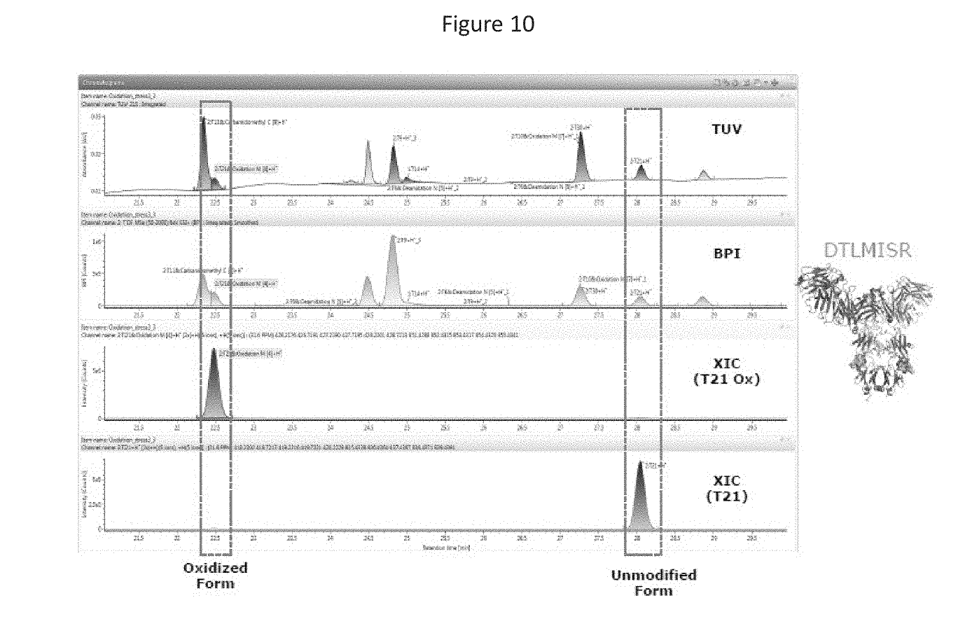

Attributes associated with oxidation were also characterized and tested. FIG. 10 shows a comparison of the MS and UV responses versus percent oxidation for HC: T21. The oxidized form is shown across different data forms (TUV, XIC, etc.). In the UV, the oxidized form is fused to another unmodified peptide peak. As a result, quantification of T21 by UV data was challenging. The XIC, however, was clear and used for quantification. The unmodified form shows a resolved peak in both the UV and XIC scans. The unmodified form was quantified using both UV and XIC.

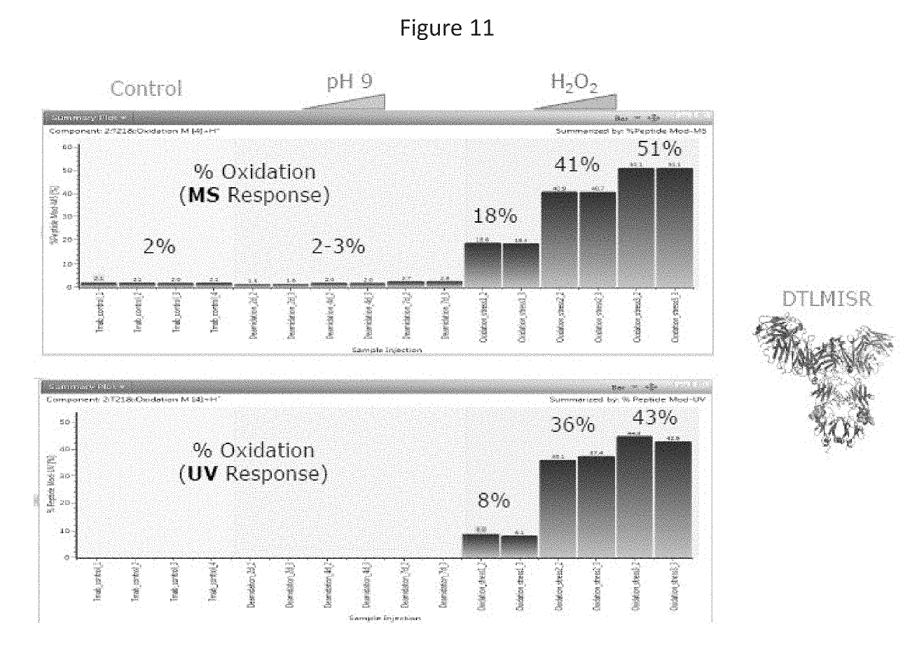

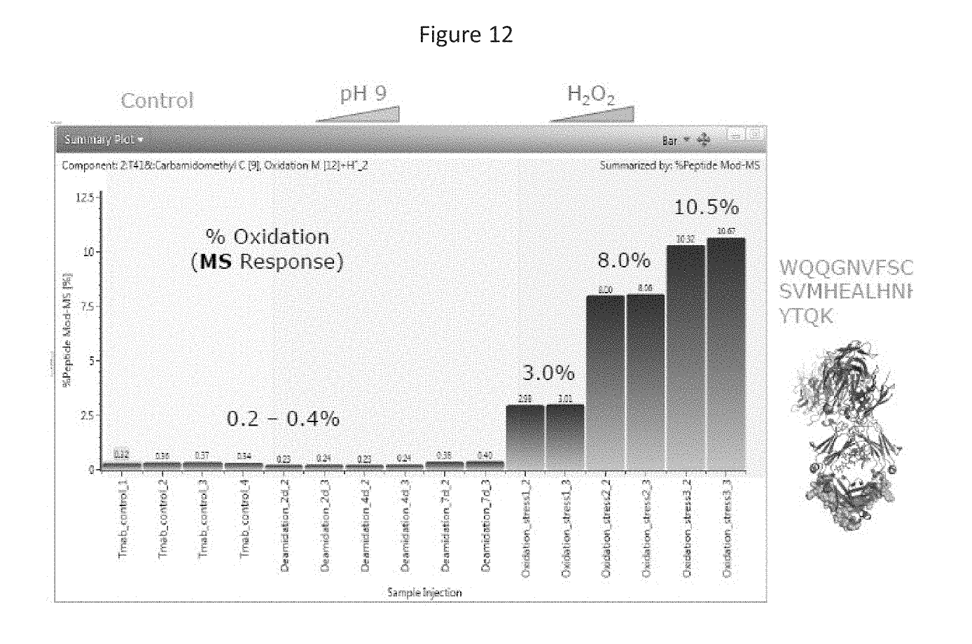

The oxidation results from the UV and XIC were compared for HC: T21 (DTLMISR) in FIG. 11. The mass data is more sensitive and can detect the 2% levels of oxidation. The mass data was also more reproducible as shown in the increased response to the peroxide stress. The UV detector could not reproducibly measure the two fused peaks individually. The mass data from the oxidation for HC: T41 (WQQGNVFSCSVMHEALHNHYTQK) is summarized in FIG. 12. The oxidized T41 is close to the c-terminus of the heavy chain with methionine groups pointing in slightly. Again, the mass data provides good detection for T41 in the high pH stress study. The mass data also shows an increasing response to the oxidation stress samples.

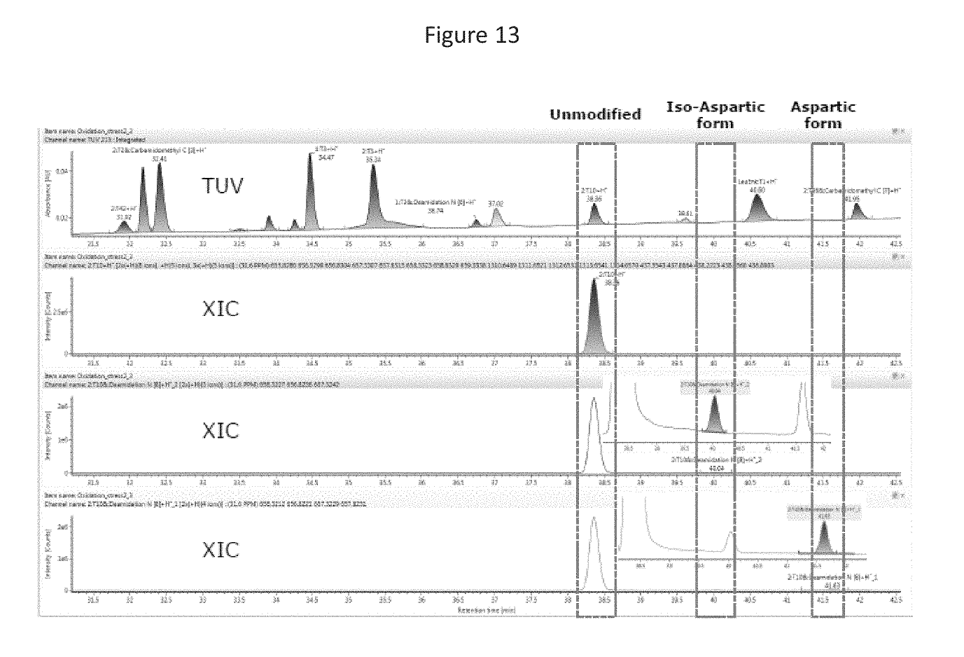

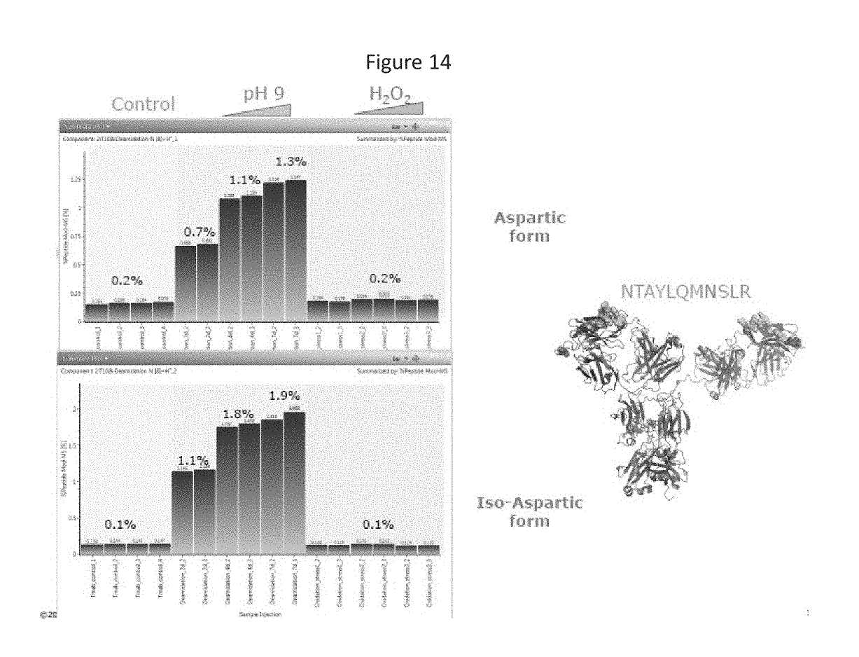

For deamidation, multiple peaks were monitored as a result of the multiple deamidation sites. FIG. 13 shows a comparison of the MS and UV chromatograms for HC:T10 deamidation NTAYLQMNSLR (N84D). The lower two XIC graphs are magnified and show resolved peaks. Both the aspartic and iso-aspartic forms are products of the deamidation. A comparison of quantitation results for aspartic and iso-aspartic forms (HC: T10 deamidation) is shown in FIG. 14. The mass data shows that the response to the high pH stress is time dependent, and the degree of deamidation in either aspartic or iso-aspartic forms display the same trends. The trending agreement between the two deamidated forms indicates the validity of MS quantification for a low-level of sample changes.

### Example 2

### Infliximab Biosimilar Study

A biosimilar comparability study was performed to highlight other characteristics of the present disclosure. Commercial infliximab is produced from a murine cell line. Infliximab biosimilar samples were reproduced using a CHO cell line. It is expected that the two cell lines will generate differences that can be identified and quantified by the present methodology. The two samples were tested using the same LC/UV/HRMS as described in Example 1.

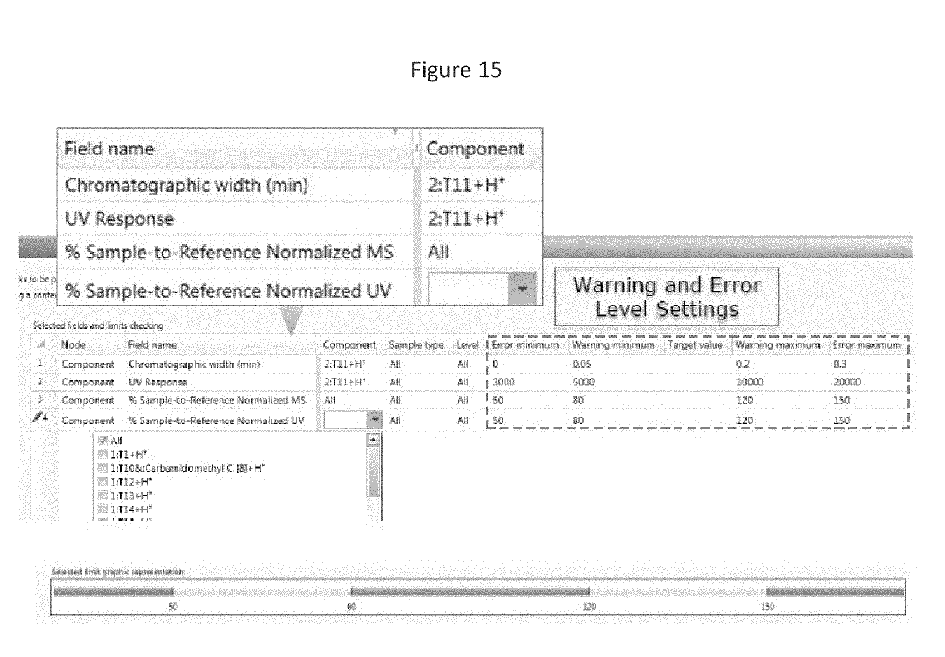

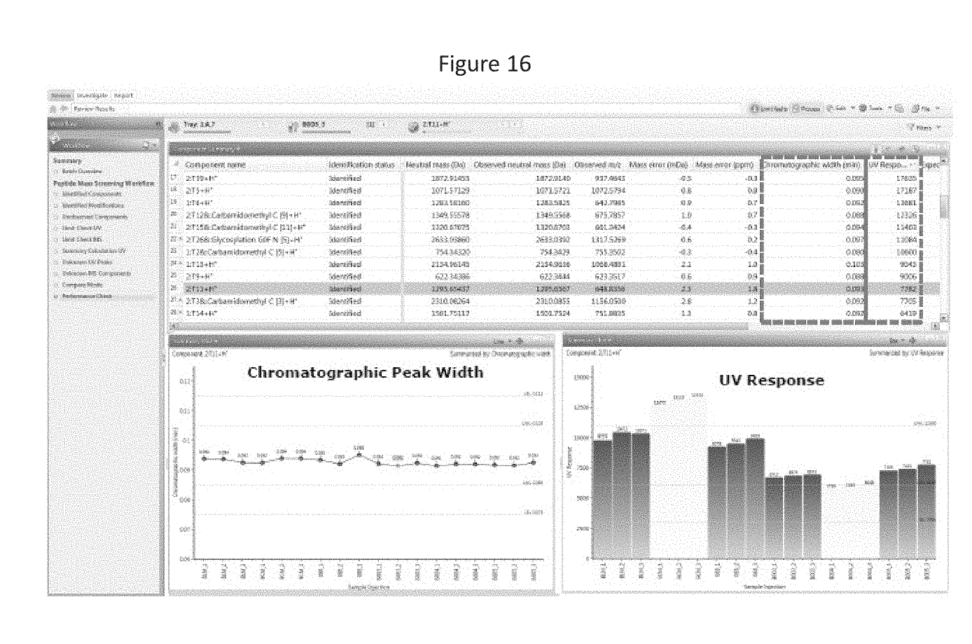

The commercial infliximab was characterized and target components associated with different attributes identified. Specifications were set based upon the characterization, as shown in FIG. 15. The software provides the ability to assess the system suitability to ensure the data is of high quality to be used for monitoring assay. It sets up an acceptable range for measurement. For example, as a part of the system suitability, the chromatographic peak width for one of the peptides was monitored and used to gauge the system suitability for the assay. FIG. 15 shows the setup of some specifications and limits based on UV response, % sample to reference normalized (MS and UV) for a component under monitoring (e.g., T11). Flags and warnings were also set to rapidly indicate whether the monitored attribute is within specification. The UV data was collected and can be used independently (to the mass signals) for monitoring purpose. As shown in FIG. 16, the chromatographic peak width was consistent and sufficient to ensure proper reproducible measurement. The UV response is shown for the peptides, suggesting an adequate amount of sample is analyzed and good measurement can be undertaken for each quantifiable component. FIG. 16 also shows the UV signal changes across samples analyzed, indicating the abundance variation of peptide T11. The yellow bars show that the abundance of the T11 in that particular sample is in the warning range already for the sample.

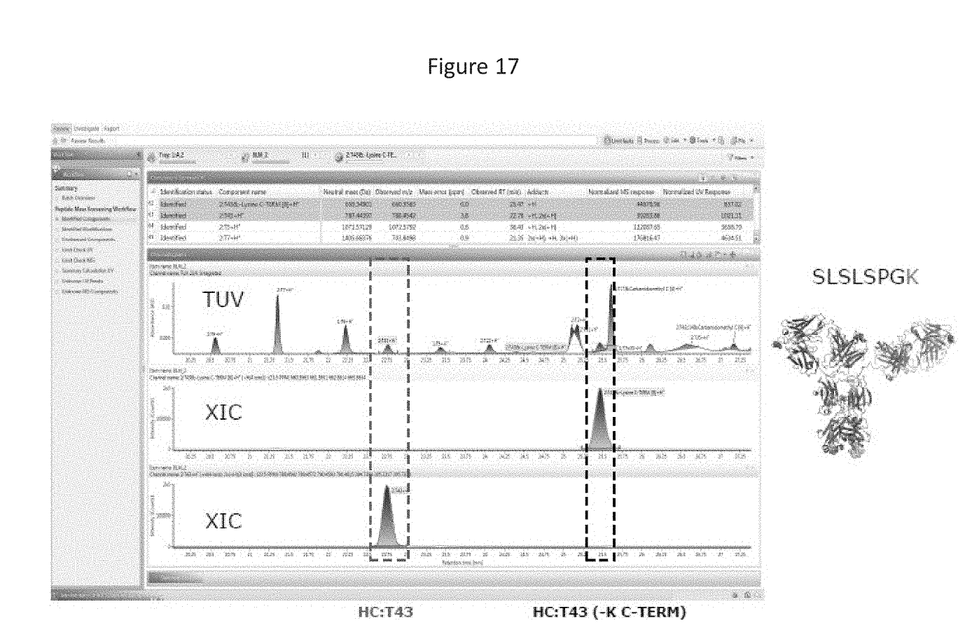

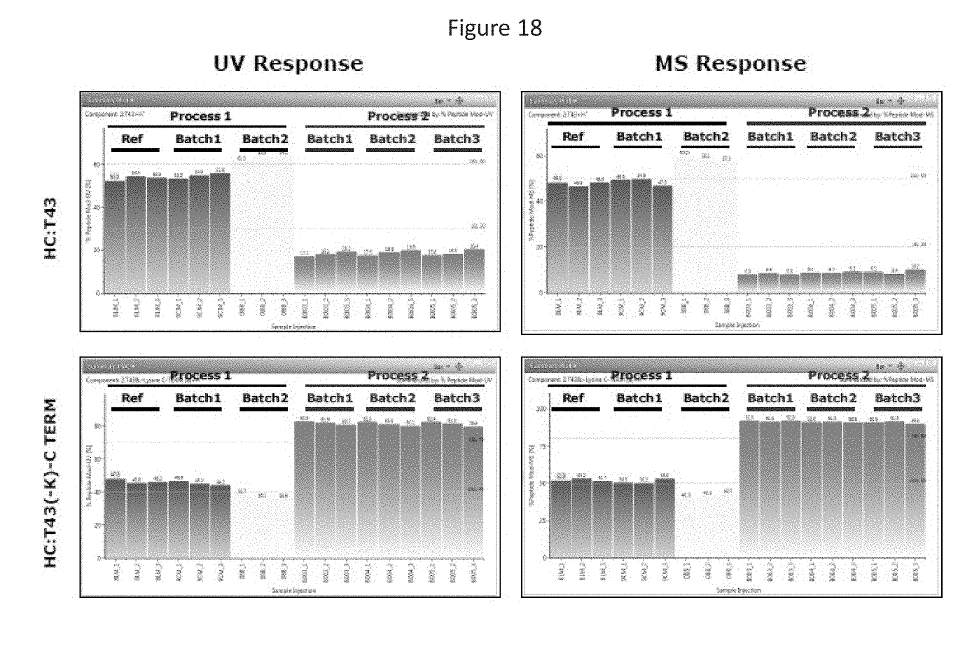

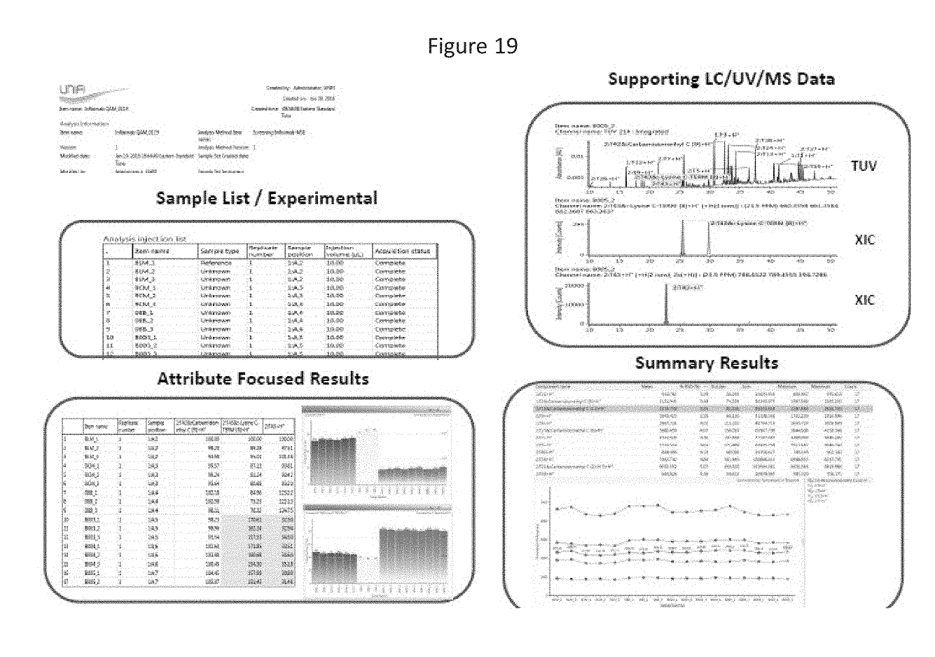

Other characteristics can also be monitored which are different among the two cell lines. For example, the lysine processing of the c-terminus peptide of the heavy chain (HC: T43 and the HC: T43 (-K c-terminus)) can be monitored, as shown in FIG. 17. The peptide with intact lysine and the peptide with processed lysine show resolved peaks which were measured using both UV and MS. FIG. 18 shows the limit check analysis for lysine variant showing differences between two processes. The data provides a simple visual to indicate the differences. The reproduced infliximab (process 2) shows almost none of the molecules have intact lysine, and have a high amount of the processed product. The software was used to produce a summarized data report. FIG. 19 shows the attribute centric report. The data was organized by attribute, e.g., oxidized peptide, and each attribute can be summarized and reported.

1. A method of multiple attributes monitoring for a biological compound comprising:
(i) characterizing a biological compound standard using a chromatography-optical detector-high resolution mass spectrometry method, wherein the characterization includes:
(a) separating the biological compound using the chromatography-optical detector and high resolution mass spectrometry method, identifying and quantifying peaks generated by the optical detector and accurate masses generated by the high resolution mass spectrometry, storing the accurate mass information in a library as accurate mass reference standard information;
(b) exposing the biological compound standard to a first condition related to a first attribute wherein the first condition induces at least one first chemical change to the biological compound standard;
(c) separating the biological compound exposed to the first condition using the chromatography-optical detector-high resolution mass spectrometry method, identifying and quantifying peaks generated by the optical detector and accurate masses generated by the high resolution mass spectrometry, comparing the accurate masses from the first condition with the accurate mass reference standard information to identify differences; and storing the accurate mass information from the first condition related to the first attribute in the library as a first list of targeted components;
(ii) determining at least one quality attribute control limit related to the first list of targeted compounds;
(iii) testing a biological compound sample using the chromatography-optical detector-high resolution mass spectrometry method, wherein the testing includes:
(a) separating the biological compound sample using the chromatography-optical detector-high resolution mass spectrometry method, identifying and quantifying peaks generated by the optical detector and accurate masses generated by the high resolution mass spectrometry, and
(b) comparing the identity and quantity of the biological compound sample peaks and accurate mass information to the library of peaks and accurate masses related to the biological compound standard and the first list of targeted components; and
(c) determining if the at least one quality attribute control limit related to the first attribute has been exceeded.

2. The method of claim 1, wherein the biological compound comprises proteins, peptides, oligonucleotides or oligosaccharides.

3. The method of claim 1, wherein the chromatography-optical detector-high resolution mass spectrometry method comprises liquid chromatography, a UV detector and a high resolution mass spectrometer operated in a data independent acquisition mode.

4. The method of claim 1, wherein the biological compound standard is characterized in a single analysis using the chromatography-optical detector-high resolution mass spectrometry method.

5. The method of claim 1, wherein the elution time of the UV peaks, the elution time of the component peaks in mass spectrometry chromatogram, or both are adjusted to match.

6. The method of claim 1, wherein the first attribute is selected from the group consisting of deamidation assessment, isomerization assessment, glycation assessment, high mannose assessment, methionine oxidation assessment, signal peptide assessment, unusual glycosylation assessment, CDR tryptophan degradation assessment, non-consensus glycosylation assessment, n-terminal pyroglutamate assessment, n-terminal truncation, c-terminal lysine assessment, galactosylation assessment, host cell protein assessment, mutations/misincorporations assessment, hydroxylysine assessment, thioether assessment, non-glycosylated heavy change assessment, fucosylation assessment, residual protein A assessment and identity assessment.

7. The method of claim 1, wherein preparation and data acquisition of the biological compound standard and the biological compound sample are the same.

8. The method of claim 1, wherein the first list of targeted components are characterized by retention time, neutral mass, confirmatory fragments, drift time, collision cross section area or combinations thereof.

9. The method of claim 1, further comprising:
exposing the biological compound standard to a second condition related to a second attribute wherein the second condition induces at least one second chemical change to the biological compound standard;
separating the biological compound exposed to the second condition using the chromatography-optical detector-high resolution mass spectrometry method, identifying and quantifying peaks generated by the optical detector and accurate mass generated by the high resolution mass spectrometry, comparing the accurate masses from the second condition with the accurate mass reference standard information to identify differences; and storing the accurate mass information from the second condition related to the second attribute in the library as a second list of targeted components,
determining at least one quality attribute control limit related to the second list of targeted components;
comparing the identity and quantity of the biological compound sample peaks and accurate mass information to the library of peaks and accurate masses related to the second list of targeted components; and
determining if the at least one quality attribute control limit related to the second attribute has been exceeded.

10. The method of claim 1, further comprising:
identifying a new component in the biological compound sample wherein the new component is determined not to be a component of a target compound stored in the library, and
generating a notification for additional characterization of the new ion in the biological compound standard, and for updating of the library.

11. The method of claim 10, wherein the new component is more than 0.1 wt % of the biological compound sample.

12. A method of multiple attribute monitoring for a biological compound comprising:
testing a biological compound sample using a chromatography-optical detector-high resolution mass spectrometry method, wherein the testing includes:
(a) separating the biological compound sample using the chromatography-optical detector-high resolution mass spectrometry method, identifying and quantifying peaks generated by the optical detector and accurate masses generated by the high resolution mass spectrometry, and
(b) comparing the identity and quantity of the biological compound sample peaks and accurate mass information to a library of peaks and accurate masses related to a biological compound standard and one or more lists of targeted components;
(c) for each accurate mass in the library, determining if a quality attribute control limit related to the one or more attributes has been exceeded;
(d) for each accurate mass not in the library, further analyzing peaks and accurate mass information from the chromatography-optical detector-high resolution mass spectrometry method and relating each accurate mass to an existing or new attribute, and store the accurate mass information related to the existing or new attribute in the library as a targeted component for the existing or new attribute.

13. The method of claim 12, further including determining at least one quality attribute control limit related to the accurate mass information related to the existing or new attribute.

14. A method of multiple attributes monitoring for a biological compound comprising:
(i) characterizing a biological compound standard using a chromatography-optical detector-mass spectrometry method, wherein the characterization includes:
(a) separating the biological compound using the chromatography-optical detector and mass spectrometry method, identifying and quantifying peaks generated by the optical detector and masses generated by the mass spectrometry, storing the mass information in a library a mass reference standard information;
(b) exposing the biological compound standard to a first condition related to a first attribute wherein the first condition induces at least one first chemical change to the biological compound standard;
(c) separating the biological compound exposed to the first condition using the chromatography-optical detector-mass spectrometry method, identifying and quantifying peaks generated by the optical detector and masses generated by the mass spectrometry, comparing the masses from the first condition with the mass reference standard information to identify differences; and storing the mass information from the first condition related to the first attribute in the library as a first list of targeted components;
(ii) determining at least one quality attribute control limit related to the first list of targeted compounds;
(iii) testing a biological compound sample using the chromatography-optical detector-mass spectrometry method, wherein the testing includes:
(a) separating the biological compound sample using the chromatography-optical detector-mass spectrometry method, identifying and quantifying peaks generated by the optical detector and masses generated by the mass spectrometry, and
(b) comparing the identity and quantity of the biological compound sample peaks and mass information to the library of peaks and masses related to the biological compound standard and the first list of targeted components; and
(c) determining if the at least one quality attribute control limit related to the first attribute has been exceeded.

15. The method of claim 14, wherein the elution time of the UV peaks, the elution time of the component peaks in mass spectrometry chromatogram, or both are adjusted to match.

16. The method of claim 14, wherein preparation and data acquisition of the biological compound standard and the biological compound sample are the same.

17. The method of claim 14, further comprising:
exposing the biological compound standard to a second condition related to a second attribute wherein the second condition induces at least one second chemical change to the biological compound standard;
separating the biological compound exposed to the second condition using the chromatography-optical detector-mass spectrometry method, identifying and quantifying peaks generated by the optical detector and mass generated by the mass spectrometry, comparing the masses from the second condition with the mass reference standard information to identify differences; and storing the mass information from the second condition related to the second attribute in the library as a second list of targeted components,
determining at least one quality attribute control limit related to the second list of targeted components;
comparing the identity and quantity of the biological compound sample peaks and mass information to the library of peaks and masses related to the second list of targeted components; and
determining if the at least one quality attribute control limit related to the second attribute has been exceeded.

18. The method of claim 14, further comprising:
identifying a new component in the biological compound sample wherein the new component is determined not to be a component of a target compound stored in the library, and
generating a notification for additional characterization of the new ion in the biological compound standard, and for updating of the library.

19. (canceled)
